(19) United States
(12) Patent Application Publication
(10) Pub. No.: US 2011/0138961 A1
(43) Pub. Date: Jun. 16, 2011

(54) CONTROL DEVICE FOR A BICYCLE DERAILLEUR

(75) Inventor: Giuseppe Dal Prà, Zane (Vicenza) (IT)

(73) Assignee: CAMPAGNOLO S.R.L., Vicenza (IT)

(21) Appl. No.: 13/019,802

(22) Filed: Feb. 2, 2011

Related U.S. Application Data
(63) Continuation of application No. 11/474,720, filed on Jun. 26, 2006, now abandoned.

(30) Foreign Application Priority Data
Jun. 27, 2005 (EP) 05425457.8

(51) Int. Cl. B62M 25/04

(52) U.S. Cl. 74/502.2

(57) ABSTRACT

A control device for driving the control cable of the derailleur of a bicycle is provided. The device has a support body connectable at one side to a handlebar of the bicycle, a cable-winding bush about which a control cable of the derailleur is wound/unwound, and a lever for driving the cable-winding bush into rotation in a first direction of rotation. Between the cable-winding bush and the side of the support body a deflection mechanism is arranged for the control cable.

### CROSS REFERENCE TO RELATED APPLICATIONS

This application is a continuation of U.S. patent application Ser. No. 11/474,720, filed Jun. 26, 2006, which claims priority to European Patent Application No. 05425457.8, filed Jun. 27, 2005, the entire contents of all of which are incorporated by reference as if fully set forth.

### FIELD OF THE INVENTION

The present invention refers to a control device used to drive a control cable of a bicycle derailleur. The following description is made with reference to devices configured in particular for bicycles with curved handlebars (typical of racing bicycles) but the invention is independent of the shape of the handlebars and the consequent configuration of the actuation device and therefore it can also be used in devices for bicycles with straight handlebars, typical of mountain bike.

### BACKGROUND

A bicycle is usually provided with two derailleurs, a front one associated with the crankset and a rear one associated with the sprocket assembly. In both cases, the derailleur engages the transmission chain displacing it on toothed wheels of different diameters and having different numbers of teeth, so as to obtain different gear ratios. The derailleur, be it the rear or front, is moved in one direction by the traction action exerted by a normally sheathed inextensible cable (commonly known as Bowden cable) and in the opposite direction by the elastic return action of a spring provided in the derailleur itself. Normally, the direction in which the displacement is carried out by the return spring is that in which the chain passes from a toothed wheel with a greater diameter to a toothed wheel with a smaller diameter, i.e. that of so-called downward gear shifting; vice-versa, the traction action of the control cable occurs in the direction of so-called upward gear shifting, in which the chain moves from a toothed wheel with a smaller diameter to a toothed wheel with a greater diameter. It should be noted that in a front derailleur downward gear shifting corresponds to the passage to a lower gear ratio, whereas in a rear derailleur it corresponds to greater gear ratio.

The displacement in the two directions of the control cable of a derailleur is obtained through a control device, commonly known as integrated control. The integrated control is mounted so as to be easily manipulated by the cyclist, i.e. normally on the handlebar, proximate the handgrips thereof. The integrated control also includes a brake lever for controlling the actuation cable of the front or rear brake. Customarily, the control device of the front derailleur and the brake lever of the front brake are located on the left side of the handlebar, and vice-versa the control device of the rear derailleur and the brake lever of the rear brake are located on the right side of the handlebar.

In the control device, the control cable is traction or release actuated through winding and unwinding on a rotor element, commonly known as cable-winding bush or bobbin, whose rotation is controlled by the cyclist using appropriate control levers.

A first type of a known integrated control device has two distinct ratchet levers which control the rotation, in the two directions, of the cable-winding bush and wherein one of the two levers also controls the brake control cable.

The control device has a support body mounted projecting from the handlebars towards the front of the bicycle, on which a first lever is mounted, corresponding to the front or rear brake lever, which rotates about a first axis when actuated by the cyclist towards the handlebar during braking. The same brake lever is rotatable about a second axis, perpendicular to the first, which controls the rotation of the cable-winding bush about its axis according to a first direction of rotation, to carry out upward gear shifting. Such a rotation substantially follows the movement of the cyclist's hand that pushes the lever inwards; by “inwards” the direction towards the main axis of the bicycle is meant.

The device also has a second lever rotatable about a third axis, parallel to the second, also actuated inwards, which causes the released rotation of the cable-winding bush, by the effect of the spring of the derailleur, in a direction of rotation opposite the first to carry out downward gear shifting.

The cable-winding bush has an indexing mechanism associated therewith, which allows the rotation of the cable-winding bush in the desired direction during gear shifting and for keeping the cable-winding bush in a fixed angular position when the two levers do not act upon it.

In a preferred embodiment of the control device, the cable-winding bush is mounted on the front end of the support body near the zone where the brake lever is hinged. The control cable is wound on the cable-winding bush about an annular throat or groove belonging to a plane substantially perpendicular to the forward direction of the bicycle. The control cable of the derailleur that winds/unwinds about the cable-winding bush projects inwardly from the support body, in a direction substantially perpendicular to a vertical plane passing through the axis of the cable-winding bush.

The aforementioned device does, nevertheless, have some drawbacks.

A first drawback is that the cable-winding bush, being mounted on the front end of the support body, is a certain distance from the handlebar, thus, the control cable of the gearshift projects from the support and causes dangerous conditions for the cyclist. For example, such a dangerous condition exists in the event that there is accidental contact with nearby cyclists in a race or, in the event of falls, where the projecting cable entangles in the handlebars of other bicycles involved in the fall.

Another drawback is the unpleasant appearance given to a bicycle by the projecting cables. Furthermore, aerodynamics are reduced by the increased drag.

An integrated control device of the known type that partially overcomes such drawbacks has two distinct ratchet levers which control the rotation, in the two directions, of the cable-winding bush that is arranged with its rotation axis substantially parallel to the advancing axis of the bicycle.

Such a type of a device has a support body fixed to the handlebar of a bicycle, on which a first lever, or brake lever, for the actuation of the brake cable, a second lever, or upward gear shifting lever, arranged adjacent along the brake lever for the upward gear shifting operation and a third lever, or downward gear shifting lever, projecting from the inner side of the support body, for the downward gear shifting operation are articulated.

The cable-winding bush has, in a cylindrical portion thereof towards the handlebar, an annular throat or groove on which the widened head of a control cable is hooked and on which the control cable itself is wound and unwound. The annular throat belongs to a plane perpendicular to the forward axis of the bicycle or travel direction and the control cable, given its rigidity, has an exit direction from the throat belonging to the same plane. The control cable is then inserted in an outer sheath arranged with its end in a cylindrical recess made in the support close to the handlebar. The control cable that comes out from the throat reaches the end of the sheath through a curved through hole.

Such a solution has a drawback in the friction that is created between the control cable and the inner surface of the through hole in the curved zone during gear shifting when the control cable slides in the through hole and inside the sheath. Such friction causes a reduction in the performances of the integrated control and an increase in wear between the parts mutually sliding in contact.

### SUMMARY

The object of the present invention is to overcome said drawbacks and create a control device without projecting cables and with characteristics of increased reliability and longer lifetime with respect to conventional control devices.

Such an object is accomplished by a control device for driving a control cable of a derailleur of a bicycle, comprising a support body connectable at one side to a bicycle handlebar and having a part projecting from said side; a cable-winding bush about which said control cable is wound/unwound at least one lever rotatable with respect to said support body to drive said cable-winding bush into rotation in a first direction of rotation, wherein it comprises a deflection mechanism for said control cable arranged between said cable-winding bush and said side of said support body.

### BRIEF DESCRIPTION OF THE DRAWINGS

Further features and advantages of the invention shall become clearer from the description of preferred embodiments, made with reference to the attached drawings, where like reference numerals correspond to like elements, wherein:

FIG. 1 is an isometric view of the control device of the invention mounted on a bicycle's handlebar;

FIG. 2 is a side view of partial sections along the section planes II-II and III-III of the control device of FIG. 1;

FIG. 3 is a diagrammatic side section view of a first embodiment of the control device of the invention; and

FIG. 4 is a diagrammatic view from above of a second embodiment of the control device of the invention;

FIG. 5 is a front view of a deflection wheel used in any one of the embodiments of the previous figures.

### DETAILED DESCRIPTION OF THE PREFERRED EMBODIMENTS

### Introduction to the Embodiments

The present invention is a control device for driving a control cable of a derailleur of a bicycle, comprising a support body connectable at one side to a bicycle handlebar and having a part projecting from said side; a cable-winding bush about which said control cable is wound/unwound; at least one lever rotatable with respect to said support body to drive said cable-winding bush into rotation in a first direction of rotation, wherein it comprises a deflection mechanism for said control cable arranged between said cable-winding bush and said side of said support body.

According to a preferred embodiment the deflection mechanism comprises a deflection wheel idle mounted on said support.

Preferably, the rotation axis of the deflection wheel is perpendicular to the rotation axis of the cable-winding bush.

Even more preferably, the outer surface of the deflection wheel has a throat for housing the control cable.

Preferably, the support body comprises a cylindrical recess made close to its side connectable to the handlebar to receive the end of the outer sheath of the control cable.

Advantageously, the control cable and the outer sheath come out from the control device adhering to the handlebar while the control cable, during gear shifting, winds on the deflection wheel with lower friction values with respect to the devices of the prior art.

### DETAILED DESCRIPTION

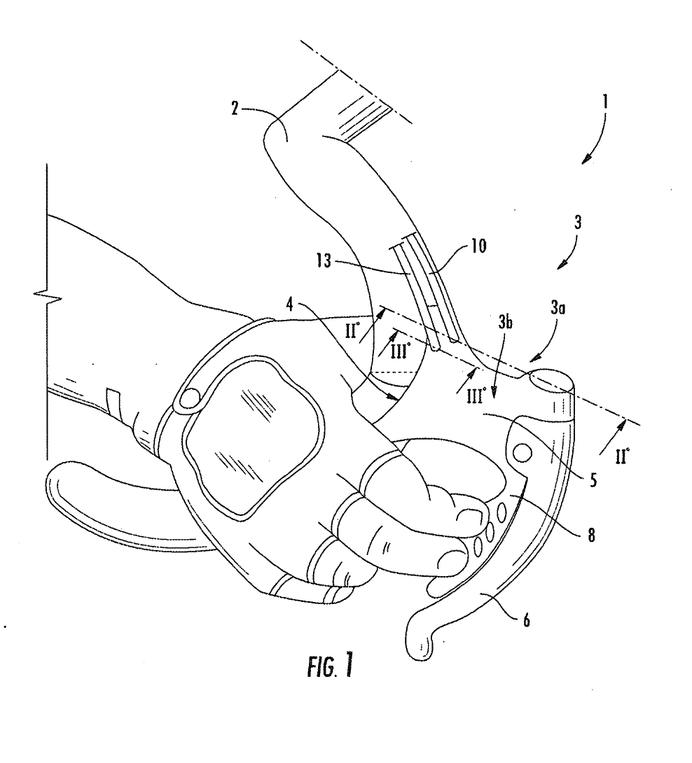

In FIG. 1 the control device 1 of the invention is shown. The control device 1 is a right control device, namely mounted on the curved right end of a handlebar 2 to carry out the gear shifting operations of the rear derailleur, but it is clear that the inventive concept can be also applied to the left control device mounted on the curved left end of the handlebar 2 and associated with the front derailleur, just as it can be applied to a right or left control device applied to straight handlebars, typical of mountain bikes.

The control device 1 comprises a support body 3 connected at one side 4 to the handlebars 2 and a part 5, projecting from the side 4, that can be gripped by the cyclist.

The support body 3 is connected to the handlebars 2 in a conventional way, for example by means of a clip (not shown).

A first lever 6, or brake lever, is associated to the support body 3. The lever 6 actuates the brake cable 7 of the rear brake (not shown).

A second lever 8, or upward gear shifting lever, is arranged adjacent along the brake lever 6, and a third lever, or downward gear shifting lever (not visible in the figure), projects from the inner side wall 3a of the support body 3. The third lever is actuated by a cyclist's thumb.

The brake lever 6 actuation acts upon the brake cable 7 which slides inside the outer sheath 10 inserted with one 10a of its ends within a first cylindrical recess 11 of the support body 3. The upward and downward gear shifting levers 8, respectively, act pulling and releasing a control cable 12 of the rear derailleur (not shown). The control cable 12 of the rear derailleur slides within the outer sheath 13 having its end 13a inserted within a second cylindrical recess 14 of the support body 3 near its side 4 that connects to the handlebars 2. The outer sheaths 10, 13 and the respective brake and control cables 7, 12, advantageously exit the control device 1 in a position adjacent to the handlebars, as can be seen in FIG. 1.

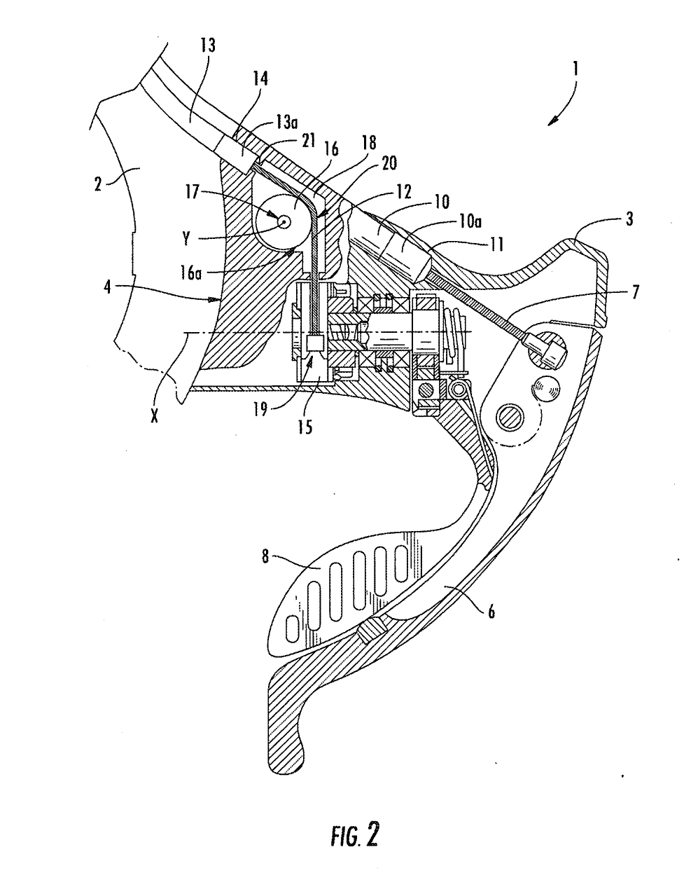

The traction and the release of the control cable 12 of the derailleur by the upward and downward gear shifting levers 8 takes place by winding and unwinding the control cable 12 about a cable-winding bush or bush 15 arranged with its rotational axis X substantially parallel to the advancing axis of the bicycle. The traction or release mechanism of the control cable 12 by the cable-winding bush 15 and the actuation of the brake cable 7 through the brake lever 6 is shown in detail in FIG. 2 and corresponds to what is described in patent EP 504 118 B1, assigned to the same Assignee of the present invention, and which is incorporated herein by reference.

As shown in FIG. 2, between the cable-winding bush 15 and the side 4 of the support body 3 that connects to the handlebar 2 of the bicycle, a deflection mechanism is arranged. The deflection mechanism comprises a deflection wheel 16, idle mounted on a central shaft 17, having on the outer surface a circumferential throat or groove 16a, visible in FIG. 5, where the control cable 12 of the rear derailleur rests. The deflection wheel 16 has a rotational axis Y substantially perpendicular to the rotational axis X of the cable-winding bush 15 and is arranged in a seat 18 formed in the support body 3 displaced, with respect to the central middle plane, towards the outer side surface 3b of the support body 3, i.e. towards the observer with reference to FIG. 2. Thus, the control cable 12 has a straight conformation between the point 19 where it is connected to the cable-winding bush 15 and the zone of first contact 20 with the outer surface of the deflection wheel 16. In the upper zone of the seat 18 an opening 21 is made for passage of the control cable 12 of the derailleur. The opening 21 is in communication with the second cylindrical recess 14 where an end 13a of the outer sheath 13 is seated. The control cable 12 is inserted straight and coaxially into the outer sheath 13 and continues along the handlebars 2 and the frame of the bicycle to the derailleur. The straight and the coaxial arrangement of the control cable 12 within the outer sheath 13 allows the contact surfaces between the control cable 12 and the outer sheath 13 themselves to be reduced substantially to zero, thereby substantially reducing the friction zones during gear shifting to zero. Moreover, during the winding and the unwinding of the control cable 12 on and from the cable-winding bush 15, i.e. during the upward and downward gear shifting operations, the control cable 12 rests upon the throat 16a of the deflection wheel 16 which rotates as a result of the movement of the control cable 12. Thus, the friction between the control cable 12 and the outer surface of the deflection wheel 16 advantageously has low values, being a rolling type friction.

In the embodiment shown and described, the angle between the straight zones of the control cable 12 defined between the point 19 where it is connected to the cable-winding bush 15 and the zone of first contact 20 with the deflection wheel 16 and between the deflection wheel 16 and the end 13a of the sheath 13 is equal to about 135°. In other embodiments, however, this angle can be varied according to the diameter and the position where the deflection wheel 16 is disposed, according to the size of the support body 3 of the control device 1 and according to the slope of the cylindrical recess 14 of the support body 3.

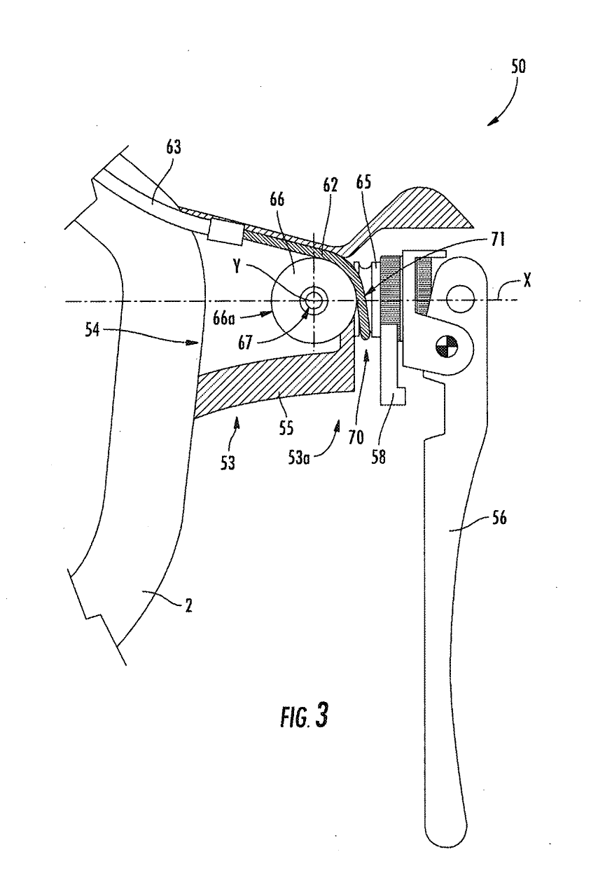

In FIG. 3 an embodiment of the control device of the invention is diagrammatically shown.

The control device 50 comprises a support body 53 connected at one side 54 to the handlebar 2 and a part 55, projecting from the side 54, that can be gripped by the cyclist.

The support body 53 is connected to the handlebar 2 in a conventional way, for example by means of a clip (not shown).

A first lever 56, or brake lever, is associated with the support body 53. The first lever 56 that actuates the actuation cable of the rear brake (not shown). Such a lever 56 also serves as the upward gear shifting lever by traction acting on the control cable 62 of the rear derailleur through the rotation of the cable-winding bush 65 in the winding direction of the control cable 62 through ratchets, not shown in the figure. Such ratchets may be, for example, as described in the U.S. Pat. No. 5,400,675. A second lever 58, arranged adjacent the first lever 56, acts to release the control cable 62 of the rear derailleur through the rotation of the cable-winding bush 65 in the unwinding direction of the control cable 62 by ratchets, not shown in the figure, and which may also be as described in the aforementioned U.S. Pat. No. 5,400,675.

The cable-winding bush 65 of the control cable 62 of the rear derailleur is positioned near the front end 53a of the support body 53 and has its rotational axis X substantially coinciding with the forward direction of the bicycle.

Between the cable-winding bush 65 and the side 54 of the support body 53 that connects to the handlebar 2 of the bicycle, a deflection wheel 66 is arranged, idle mounted on a central shaft 67, having on its outer surface a circumferential throat or groove 66a, shown in FIG. 5, on which the control cable 62 of the rear derailleur rests. The deflection wheel 66 has its rotational axis Y substantially perpendicular to the rotational axis X of the cable-winding bush 65 and is arranged in a seat or opening of the support body 53 displaced, with respect to the central middle plane, towards the outer side surface of the support body 53. Thus, the control cable 62 has a substantially straight conformation between zone 70 where it leaves the cable-winding bush 65 and zone 71 where it first contacts the outer surface of the deflection wheel 66. The control cable 62 of the derailleur is inserted straight and coaxially into the outer sheath 63 and continues within it along the handlebar 2 and the frame of the bicycle to the derailleur. Like for the solution described with reference to FIGS. 1 and 2, the contact surfaces between the control cable 62 and the outer sheath 63 are reduced substantially to zero and the rolling friction between the control cable 62 and the outer surface of the deflection wheel 66 advantageously has low values.

Moreover, the control cable 62 and the outer sheath 63 exit the control device 50 in a position near to the handlebar 52 and do not project from the control device 50 itself.

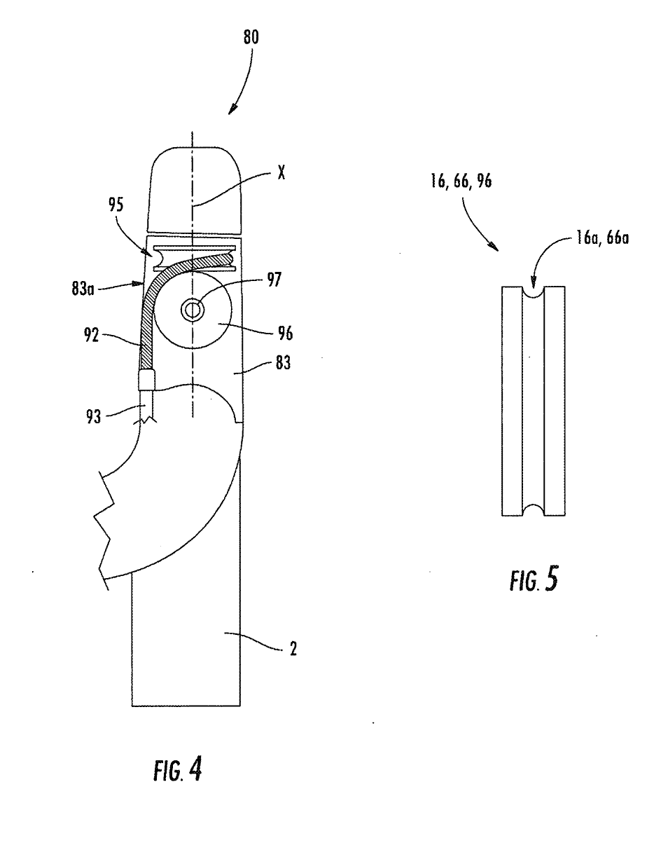

In FIG. 4 another embodiment of the control device 80 of the invention is diagrammatically shown.

This solution differs from the one shown in FIG. 3 in the different arrangement of the deflection wheel 96. The deflection wheel 96 is idle mounted on its central shaft 97, perpendicular to the rotational axis X of the cable-winding bush 95, and it is arranged in a seat formed on top of the support body 83.

With such an arrangement of the deflection wheel 96, the control cable 92 and the outer sheath 93 exit from the control device 80 adjacent the handlebar 2 and towards the inner side wall 83a of the support body 83.

1. Control device for driving a control cable of a bicycle derailleur, comprising:
a support body connectable at one side to an end portion of the bicycle handlebars and having a part projecting from said side;
a cable-winding bush about which said control cable is wound/unwound, having a rotation axis essentially perpendicular to the end portion of the bicycle handlebars;
at least one lever rotatable with respect to said support body to drive said cable-winding bush into rotation in a first direction of rotation,
said control cable coming out from said support body from said side connectable to the handlebars,
wherein a deflection mechanism for said control cable is arranged between said cable-winding bush and said side of said support body, said deflection mechanism comprising a wheel idle mounted in said support body.

2. Device according to claim 1, wherein said deflection wheel has a rotational axis substantially perpendicular to the rotational axis of said cable-winding bush.

3. Device according to claim 1, wherein said deflection wheel circumferentially has a throat housing said control cable.

4. Device according to claim 1, wherein said support body has a recess adapted for receiving an end of an outer sheath for said control cable.

5. Device according to claim 4, wherein said recess is proximate said side of said support body.

6. Device according to claim 1, further comprising a brake lever for actuating a brake cable.

7. Device according to claim 6, wherein said brake lever and said at least one lever coincide.

8. Device according to claim 6, wherein said support body has a recess adapted for receiving an end of an outer sheath for said brake cable.

9. Device according to claim 8, wherein said recess is proximate said side of said support body.

10. Device according to claim 1, further comprising a second lever rotatable with respect to said support body to drive said cable-winding bush into rotation in a second direction of rotation opposite the first.
